(19) United States
(12) Patent Application Publication
(10) Pub. No.: US 2023/0123877 A1
(43) Pub. Date: Apr. 20, 2023

(54) MATERIAL TRACKING BASED ON VEHICLE WORK TOOL LOCATION

(71) Applicant: Caterpillar Inc., Peoria, IL (US)

(72) Inventors: Nicholas A. Hanauer, Washington, IL (US); Eric W. Cler, Oswego, IL (US)

(73) Assignee: Caterpillar Inc., Peoria, IL (US)

(21) Appl. No.: 17/504,154

(22) Filed: Oct. 18, 2021

(51) Int. Cl. G01S 19/14; G05B 15/02

(52) U.S. Cl. CPC G01S 19/14; G05B 15/02; E02F 9/264

(57) ABSTRACT

A worksite controller can automatically track movement of material on a worksite, based on location information and work event information provided by vehicles on the worksite. The worksite controller can determine and/or use a location of a work tool of a vehicle, rather than coordinates determined by a location sensor mounted elsewhere on the vehicle, to determine when the work tool is located within defined boundaries of work zones associated with material. When the worksite controller determines that the vehicle performed a work event to interact with material while the work tool was within a particular work zone, the worksite controller can automatically update material tracking information associated with the work zone.

### TECHNICAL FIELD

The present disclosure relates to tracking movement of material around a worksite and, more particularly, to tracking material movement based on a location of a work tool of a vehicle.

### BACKGROUND

Work on a worksite may involve vehicles moving material from one location to another. For example, at a mine site, a vehicle such as a wheel loader may be tasked with moving rocks from a pile to a crusher. A worksite controller, such as a computer or server executing one or more computer applications, can track information associated with the worksite. For example, the worksite controller can be used to track locations of vehicles and materials on the worksite, to assign vehicles to perform work tasks, to determine how much material has been moved and/or processed at the worksite, and/or to perform other operations or analysis associated with the worksite.

A vehicle may have a location sensor that can determine coordinates of the vehicle, which the worksite controller can use to track the location of the vehicle over time as discussed above. However, in some situations, the coordinates provided by the location sensor of a vehicle can be insufficient to determine whether a work tool of the vehicle interacted with material at a worksite. For instance, a worksite may have a first pile of a material and a second pile of material. If a location sensor positioned at a cab of a wheel loader provides coordinates indicating that the cab of the wheel loader is located between the two piles of material, it may be unclear whether the vehicle is driving between the two piles of material, is using a bucket of the wheel loader to interact with the first pile of material while the cab of the wheel loader is between the two piles, is using the bucket of the wheel loader to interact with the second pile of material while the cab of the wheel loader is between the two piles, or is performing any other operation while the cab of the wheel loader is between the two piles.

Various systems have been developed to determine locations of vehicles, and/or to determine corresponding orientations or travel headings of vehicles on a worksite. For example, U.S. Pat. No. 10,168,714 to Webber et al. (hereinafter “Webber”) describes a system that uses at least two global navigation satellite sensor system (GNSS) sensors mounted on a vehicle to determine a heading angle of the vehicle, based on relative locations of points on the vehicle determined by the at least two GNSS sensors.

However, the system described by Webber can be impractical to determine whether a work tool of a vehicle is or is not interacting with material on a worksite. For instance, if one of the two GNSS sensors Webber relies upon is mounted on a work tool of a vehicle, that GNSS sensor would be at a high risk of being damaged or lost when the work tool is used for work operations. As an example, if a GNSS sensor were mounted on a bucket of a wheel loader in order to provide data indicating a location of the bucket, and/or data that could be used to determine a heading of the wheel loader, that GNSS sensor may be exposed to harsh conditions, become damaged, or fall off the bucket when the bucket is used to dig into a pile of rocks, dirt, sand, or other material. It may also be expensive and/or lead to extra maintenance to provide each vehicle on a worksite with at least two GNSS sensors at described by Webber.

The example systems and methods described herein are directed toward overcoming one or more of the deficiencies described above.

### SUMMARY OF THE INVENTION

According to a first aspect, a computer-implemented method includes receiving, by one or more processors, location data indicating first coordinates determined by a location sensor of a vehicle. The location sensor is positioned, on the vehicle, an offset distance away from a work tool point associated with a work tool of the vehicle. The computer-implemented method also includes determining, by the one or more processors, a heading of the vehicle, based on the first coordinates and at least one preceding set of coordinates determined by the location sensor of the vehicle. The computer-implemented method further includes determining, by the one or more processors, second coordinates of the work tool point, by adjusting the first coordinates by the offset distance along a direction indicated by the heading. The computer-implemented method also includes determining, by the one or more processors, that the second coordinates of the work tool point are within boundaries of a work zone. The computer-implemented method additionally includes determining, by the one or more processors, that the vehicle engaged in a work event associated with a material, at a time at which the second coordinates of the work tool point are within the boundaries of the work zone. The computer-implemented method further includes adjusting, by the one or more processors, zone data associated with the work zone, by changing a material amount value indicating an amount of the material stored in the work zone based on the work event.

According to a further aspect, a computing system includes one or more processors and memory storing computer-executable instructions. The computer-executable instructions, when executed by the one or more processors, cause the one or more processors to perform operations. The operations include receiving location data indicating first coordinates of a location sensor of a vehicle. The location sensor is positioned, on the vehicle, an offset distance away from a work tool point associated with a work tool of the vehicle. The operations also include determining a heading of the vehicle, based on the first coordinates and at least one preceding set of coordinates determined by the location sensor of the vehicle. The operations further include determining second coordinates of the work tool point, by adjusting the first coordinates by the offset distance along a direction indicated by the heading. The operations additionally include determining that the second coordinates of the work tool point are within boundaries of a work zone. The operations also include determining that the vehicle engaged in a work event associated with a material, at a time at which the second coordinates of the work tool point are within the boundaries of the work zone. The operations further include adjusting zone data associated with the work zone, by changing a material amount value indicating an amount of the material stored in the work zone based on the work event.

According to another aspect, a worksite controller includes one or more processors and memory. The memory stores zone data associated with a work zone on a worksite. The zone data indicates boundaries of the work zone, and an amount of a material stored at the work zone. The memory also stores computer-executable instructions that, when executed by the one or more processors, cause the one or more processors to perform operations. The operations include receiving, from a vehicle, a vehicle report indicating work event data and location data. The operations also include determining, based on the location data, a geographical location of a work tool point on a work tool of the vehicle. The operations further include determining that the geographical location of the work tool point is within the boundaries of the work zone. The operations additionally include determining, based on the work event data, that the vehicle engaged in a work event associated with the material, at a time at which the geographical location of the work tool point is within the boundaries of the work zone. The operations also include adjusting, in the zone data, the amount of the material stored at the work zone based on the work event data.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 shows an example of a worksite where a vehicle can use a work tool to interact with material.

FIG. 2 shows an example of historical locations of the vehicle associated with travel of the vehicle around the worksite over time.

FIG. 3 shows an example of determining a location of a work tool point associated with the work tool of the vehicle.

FIG. 4 shows an example of a situation in which determining a location of a work tool point, associated with a work tool of a vehicle, can be used to track material on the worksite.

FIG. 5 shows a flowchart illustrating an example process for tracking material on the worksite,

FIG. 6 shows an example system architecture for a computing system.

### DETAILED DESCRIPTION

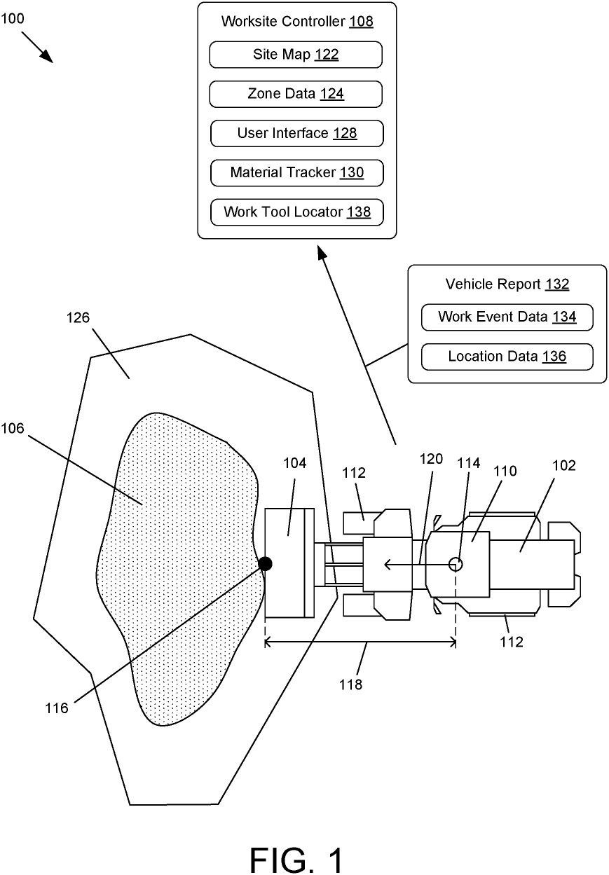

FIG. 1 shows an example of a worksite 100 where a vehicle 102 can use a work tool 104 to interact with material 106. The material 106 on the worksite 100 can include rocks, gravel, dirt, sand, lumber, construction material, and/or any other type of material. In some examples, more than one type of material 106 can be present on the worksite 100. The work tool 104 of the vehicle can be used to carry material 106, push material 106, crush material 106, scape material 106, and/or otherwise move or interact with material 106 on the worksite 100. As discussed further below, a worksite controller 108 associated with the worksite 100 can be an offboard computing system that is configured to automatically track movement of material 106 on the worksite 100 based on locations of the work tool 104 of the vehicle 102, and locations of work tools of other vehicles, over time.

The worksite 100 can be a mine site, a quarry, a construction site, or any other type of worksite or work environment. The vehicle 102 can be a commercial vehicle or work vehicle that is configured to travel around the worksite 100 and interact with one or more types of material 106. For example, the vehicle 102 can be a mining vehicle, an earth-moving vehicle, a backhoe, a scraper, a dozer, a loader (e.g., wheel loader, track-type loader, etc.), a shovel, a crane, a pipe layer, farming equipment, or any other type of vehicle that has a work tool configured to move or otherwise interact with material 106.

For example, the vehicle 102 can be a wheel loader, excavator, backhoe loader, or other type of vehicle that has at least one bucket attached to a body of the vehicle 102 by cylinders, arms, booms, or other components. In this example, the bucket can be the work tool 104 of the vehicle 102, such that the vehicle 102 can move the bucket to pick up, carry, and/or dump material 106 on the worksite 100. In other examples, the work tool 104 can be a scraper, ripper, blade, pusher, fork, grapple, plow, or any other type of work tool configured to move or otherwise interact with material 106 on the worksite 100.

The vehicle 102 can have a cab 110 that includes operator controls, such as a steering wheel, levers, buttons, and/or other types of controls. A driver or operator in the cab 110 can use the operator controls to direct operations of the vehicle 102, for instance to drive the vehicle 102 and/or to move the work tool 104. The vehicle 102 can also have engines, motors, drivetrains, braking systems, hydraulic components, and/or other mechanisms that can cause movement of wheels 112 of the vehicle 102, movement of the work tool 104 relative to the cab 110 and/or other portions of the vehicle 102, and/or otherwise implement operations of the vehicle 102.

The vehicle 102 can have a location sensor 114. The location sensor 114 can be a Global Positioning System (GPS) sensor, another type of GNSS sensor, or any other type of location and/or positioning sensor. The location sensor 114 can be located at a fixed position on the vehicle 102 that is distanced at least partially away from the work tool 104. For example, the location sensor 114 can mounted on or in the cab 110, or otherwise be located proximate to a midpoint of the vehicle 102. The location sensor 114 can be configured to determine coordinates of the geographical location of the location sensor 114, and thus the geographical location of the point where the location sensor 114 is fixed on the vehicle 102. The coordinates can be geographical coordinates, such as latitude and longitude coordinates, coordinates relative to a fixed location on the worksite 100, and/or any other type of coordinates that indicate the location of the location sensor 114 on the worksite 100. In some examples, coordinates determined by the location sensor 114 can be transmitted to the worksite controller 108, as discussed further below.

In some examples, the location sensor 114 can be configured to determine coordinates on a regular and/or relatively frequent basis, such as every second. However, in some examples, a subset of the coordinates determined by the location sensor 114 over time can be stored and/or transmitted to the worksite controller 108. The subset of the coordinates determined by the location sensor 114 that are stored and/or transmitted to the worksite controller 108 can be associated with time intervals, distance intervals, and/or other criteria.

As a non-limiting example, the location sensor 114 can be configured to determine coordinates every second, but the vehicle 102 may transmit the latest set of coordinates determined by the location sensor 114 to the worksite controller 108 every five seconds, every ten seconds, or at any other time interval. As another example, when the vehicle 102 is traveling, the vehicle 102 may transmit the latest set of coordinates determined by the location sensor 114 to the worksite controller 108 every five meters, every ten meters, or at any other distance interval. In some examples, the vehicle 102 can be configured to transmit the latest set of coordinates determined by the location sensor 114 based on a distance interval when the vehicle 102 is moving, and can be configured to transmit the latest coordinates determined by the location sensor 114 based on a time interval when the vehicle 102 is stationary or is moving at slower than a threshold speed.

The work tool 104 can be positioned at least partially away from the position of the location sensor 114 on the vehicle 102. For example, if the location sensor 114 is positioned at a midpoint of the vehicle 102, for instance at a position on or in the cab 110, the work tool 104 can be positioned at a front end of the vehicle 102, at a back end of the vehicle 102, or at another position away from the midpoint of the vehicle 102 where the location sensor 114 is positioned. Accordingly, the coordinates determined by the location sensor 114, indicating a location of the location sensor 114 on the worksite 100, may not specifically indicate the location of the work tool 104 on the worksite 100.

The work tool 104 can be associated with a work tool point 116 that is an offset distance 118 away from the position of the location sensor 114. The work tool point 116 can be a point that, based on a top view of the vehicle 102 as shown in FIG. 1, is positioned at a front edge of the work tool 104, at a midpoint of the work tool 104, at a back edge of the work tool 104, or at any other position on the work tool 104. In examples in which the work tool 104 can extend, retract, and/or otherwise move relative to the cab 110 or other portions of the vehicle 102, the work tool point 116 can be positioned based on an average position of the work tool 104 relative to other portions of the vehicle 102 over a period of time, a maximum extended position of the work tool 104 relative to other portions of the vehicle 102, a retracted position of the work tool 104, and/or any other possible position of the work tool 104 relative to other portions of the vehicle 102.

The offset distance 118 can accordingly indicate a fixed distance between the position of the location sensor 114 and the work tool point 116 associated with the work tool 104. In some examples, the offset distance 118 can be a positive value if the work tool point 116 is positioned in front of the location sensor 114 at or towards a front end of the vehicle 102. Similarly, the offset distance 118 can be a negative value if the work tool point 116 is positioned behind the location sensor 114 at or towards a back end of the vehicle 102.

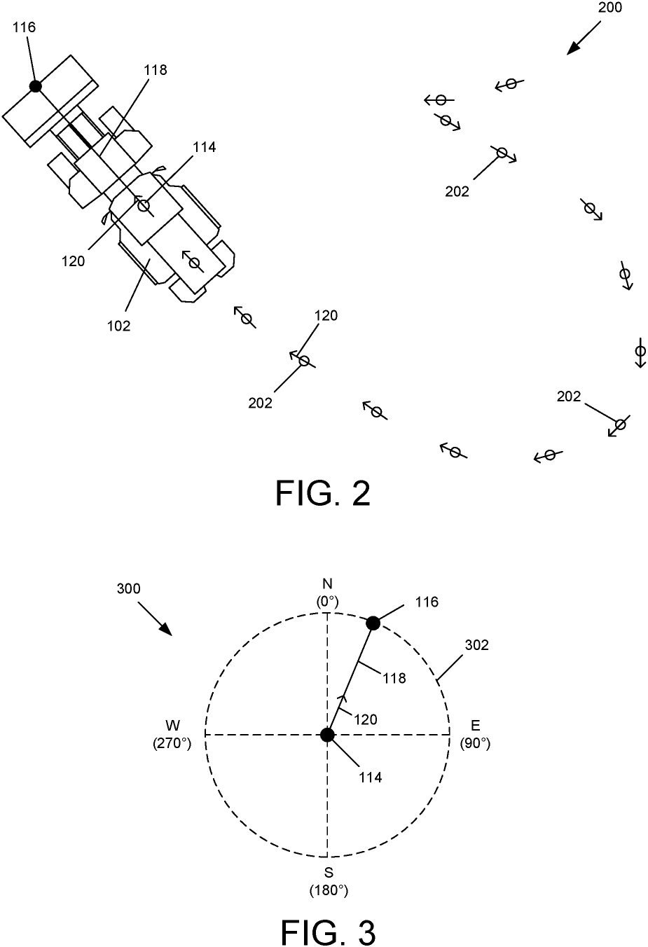

The vehicle 102 can be oriented, on the worksite 100, based on a heading 120. The heading 120 can be an angle or direction that the vehicle 102 is, or would be, moving toward if the vehicle 102 drives forward without turning. For example, based on the top view shown in FIG. 1, the heading 120 can be based on the direction of a vector extending from the cab 110 toward the front of the vehicle 102. The heading 120 of the vehicle 102 can be determined based on coordinates of locations determined by the location sensor 114 over time, as will be discussed in further detail below with respect to FIG. 2.

Coordinates of a location of the work tool point 116 on the worksite 100 can be determined based on coordinates determined by the location sensor 114, the offset distance 118, and the heading 120. The coordinates of the work tool point 116 can be at a location that is the offset distance 118 away from coordinates indicated by the location sensor 114, along a direction indicated by the heading 120. Accordingly, the coordinates of the work tool point 116 can be determined by adjusting the coordinates of the location sensor 114 by the offset distance 118 along the direction indicated by the heading 120. Determination of the location of the work tool point 116 based on the location of the location sensor 114, the offset distance 118, and the heading 120 is discussed further below with respect to FIG. 3.

As a first non-limiting example, if the work tool point 116 is ten feet directly in front of the location sensor 114 on the vehicle 102, the offset distance 118 can be ten feet. The location sensor 114 can determine that the location sensor 114 is located at particular coordinates on the worksite 100. The heading 120 of the vehicle 102 can indicate that the vehicle 102 is oriented towards the west at 270 degrees relative to north. Accordingly, in this example, the location of the work tool point 116 on the worksite 100 can be at coordinates that are ten feet along a line that extends west, at 270 degrees relative to north, from the coordinates of the location sensor 114. If the vehicle 102 moves such that the heading 120 of the vehicle 102 changes to be oriented toward the northwest at 315 degrees relative to north, the location of the work tool point 116 on the worksite 100 can be at coordinates that are ten feet along a line that extends northwest, at 315 degrees relative to north, from the coordinates of the location sensor 114.

As a second non-limiting example, if the work tool point 116 is five feet directly behind of the location sensor 114 on the vehicle 102, the offset distance 118 can be negative five feet. The location sensor 114 can determine that the location sensor 114 is located at particular coordinates on the worksite 100. The heading 120 of the vehicle 102 can indicate that the vehicle 102 is oriented towards the west at 270 degrees relative to north. In this example, because the work tool point 116 is behind the location sensor 114 on the vehicle 102 and the offset distance 118 is negative five feet, the location of the work tool point 116 on the worksite 100 can be at coordinates that are negative five feet along a line that extends west, at 270 degrees relative to north, from the coordinates of the location sensor 114. In other words, the location of the work tool point 116 on the worksite 100 can be at coordinates that are five feet along a line that extends east, at 90 degrees relative to north, from the coordinates of the location sensor 114.

The worksite controller 108 can be configured to automatically monitor and/or analyze movement of material 106 around the work site 100. In particular, the worksite controller 108 can be configured to monitor and/or analyze movement of material 106 based on locations of the work tool point 116 over time, instead of or in addition to locations of the location sensor 114 itself over time.

The worksite controller 108 can have a site map 122 associated with the worksite 100. The site map 122 can indicate boundaries of the worksite 100, terrain of the worksite 100, locations and/or identities of obstacles on the work-site 100, and/or other information associated with the worksite 100. For example, the site map 122 can indicate locations of fixed and/or movable obstacles on the worksite 100, such as other vehicles, personnel, lakes, ponds, rivers, cliff faces, hills, roads, intersections, and/or other types of objects, terrain features, or obstacles.

The worksite controller 108 can also maintain zone data 124 associated with at least one work zone 126 at the worksite 100. As discussed above, material 106 can be moved around the work-site 100. For instance, the vehicle 102 and/or other vehicles can be tasked with moving material 106 from one location to another location on the worksite 100. Each of the locations where material 106 is to be stored, picked up, dropped off, and/or otherwise interacted with can be associated with a corresponding work zone. The zone data 124 associated with a particular work zone can indicate a location of the work zone on the worksite 100, boundaries of the work zone on the work site 100, material tracking information indicating a type of material 106 associated with the work zone and/or an amount of material 106 associated with the work zone, and/or other data associated with the work zone. In some examples, the zone data 124 can indicate a geofence associated with the location and/or borders of a work zone, for instance based on geographical coordinates of user-selected areas of the site map 122.

The worksite controller 108 can have a user interface 128 that a user can access directly through the worksite controller 108 or indirectly via a separate computer, mobile device, or other computing device. The user interface 128 can allow users to view and/or edit information associated with the worksite 100, including the zone data 124, information indicating locations of material 106, information associated with movement of material 106, information associated with the vehicle 102 and/or other vehicles, and/or other types of information.

For example, users can use the user interface 128 to provide user input that defines one or more work zones at the worksite 100. As material 106 is moved around the worksite 100, users may also use the user interface 128 to provide user input to adjust the locations and/or boundaries of work zones associated with the material 106, create new work zones, and/or delete work zones. As an example, vehicles may be tasked to move gravel from a first pile to a second pile on the worksite 100. In this example, a user can define a first work zone with boundaries on the site map 122 that surround the first pile of gravel, and define a second work zone with boundaries on the site map 122 that surround the second pile of gravel. As work progresses, such that the first pile of gravel gets smaller and the second pile of gravel gets larger as vehicles move the gravel from the first pile to the second pile, the user can adjustthe boundaries of the work zones to decrease the size of the first work zone and increase the size of the second work zone. When the gravel has been fully removed from the first pile, the user may delete the first work zone. As discussed further below, in some examples the worksite controller 108 can also, or alternately, automatically adjust boundaries and/or sizes of work zones, automatically create and delete work zones, or use the user interface 128 to suggest changes to the work zones.

The worksite controller 108 can also have a material tracker 130 that is configured to automatically determine when material 106 is moved around the worksite, for instance from one work zone to another work zone. As will be discussed further below, the material tracker 130 can use vehicle reports indicating payload amounts, work tool movements, hydraulic pressures, and/or other types of data to determine when and where vehicles likely performed operations to pick up material 106, transport material 106, drop material 106, and/or otherwise interact with material 106. When the material tracker 130 determines that a vehicle likely moved material 106 from one work zone to another work zone, the material tracker 130 can update zone data 124 and/or other information that indicates types and/or amounts of material 106 associated with the work zones.

In some examples, the material tracker 130 can also be configured to analyze data associated with movement of material 106 on the worksite 100 over time. For example, the material tracker 130 can be configured to determine average cycle times of work cycles that involve vehicles picking up material 106 from a first work zone, transporting the material 106 to a second work zone, dropping the material 106 at the second work zone, and then returning to the first work zone to pick up additional material 106. As another example, the material tracker 130 can be configured to determine a number of work cycles performed by one or more vehicles in a day, week, or other period of time. As still other examples, the material tracker 130 can be configured to determine how much material 106 was likely moved between work zones over a period of time, to determine how much material 106 was likely added to one or more work zones over a period of time, to determine how much material 106 was likely consumed from one or more work zones over a period of time, and/or to determine other types of metrics associated with tracking of material 106 on the worksite 100.

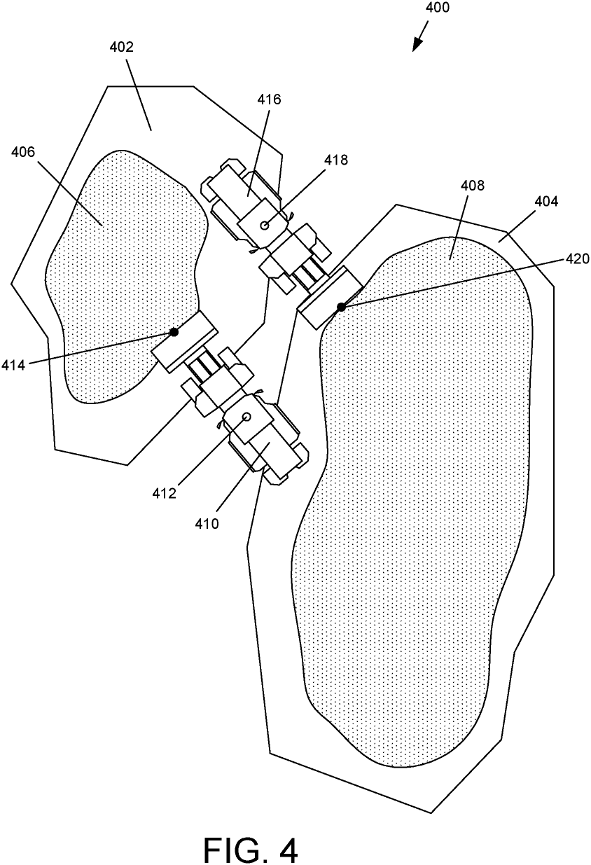

As shown in FIG. 1, in some situations the work tool 104 of the vehicle 102 can interact with material 106 in a particular work zone, such as work zone 126, even though the location of the location sensor 114 may be outside the work zone. For example, if the work zone 126 is associated with a geofence that surrounds a pile of material 106, and the boundaries of the geofence are relatively close to the edge of the pile of material 106, the work tool 104 may enter the work zone 126 to pick up material 106 from the pile or to drop material 106 on the pile. However, the cab 110 and/or other portions of the vehicle 102 may remain outside the work zone 126 while the work tool 104 is interacting with the material 106 inside the work zone 126. In some examples, as discussed further below with respect to FIG. 4, the cab 110 and/or other portions of the vehicle 102 may be located within a different work zone while the work tool 104 is interacting with material 106 inside the work zone 126. Accordingly, the material tracker 130 of the worksite controller 108 can be configured to use location data indicating locations of the work tool point 116 on the worksite 100 over time, instead of or in addition to indications of locations of the location sensor 114 itself, to determine when the work tool 104 interacts with material 106 in the work zone 126 and/or when corresponding material tracking information associated with the work zone 126 is to be updated.

The material tracker 130 can determine locations of the work tool point 116 on the worksite 100 over time based on a vehicle report 132 transmitted by the vehicle 102 to the worksite controller 108. The vehicle 102 can be configured to periodically or occasionally transmit new vehicle reports to the worksite controller 108. The vehicle 102 and the worksite controller 108 can have, or be associated with, one or more wireless communication interfaces, such as cellular interfaces, WiFi® interfaces, Bluetooth® interfaces, machine-to-machine data interfaces, and/or other types of wireless communication interfaces. The wireless communication interfaces can include modems, receivers, transmitters, antennas, and/or other hardware or software elements configured to send and receive data. Accordingly, the vehicle 102 can use one or more wireless communication interfaces to transmit the vehicle report 132 to the worksite controller 108.

The vehicle report 132 can include work event data 134. The work event data 134 can include information determined based on sensors and/or other components of the vehicle 102, such as data indicating payload amounts, data indicating hydraulic pressures, data indicating commands or other user input provided by an operator of the vehicle 102, speed data, acceleration data, drivetrain output torque data, transmission gear data, movement data that indicates movements, relative positions, and/or orientations of the work tool 104, linkages, and/or other components of the vehicle 102, and/or other types of data that can be indicative of work events associated within interactions between the work tool 104 and material 106. For example, when the work event data 134 indicates that a payload and/or hydraulic pressures associated with the work tool 104 increased, the increase in such values can indicate that the work tool 104 performed an operation to pick up material 106. Similarly, if the work event data 134 instead indicates that a payload and/or hydraulic pressures associated with the work tool 104 decreased, the decrease in such values can indicate that the work tool 104 performed an operation to drop off material 106. As another example, operator commands, changes in drivetrain output torque, movement data indicating changes to orientations of the work tool 104 relative to other portions of the vehicle 102, and/or other factors can be indicative of performance of a work event, instead of or in addition to payload changes and/or hydraulic pressure changes.

The vehicle report 132 can also include location data 136. In some examples, the location data 136 in the vehicle report 132 can indicate coordinates determined by the location sensor 114. As discussed above, the vehicle 102 can be configured to transmit at least a subset of the coordinates determined by the location sensor 114 over time, such as coordinates determined at times separated by one or more defined time intervals, and/or when the vehicle 102 has traveled distances associated with one or more defined distance intervals. In these examples, the worksite controller 108 can be configured to determine corresponding coordinates of the work tool point 116 based on the coordinates of the location sensor 114, the offset distance 118, and the heading 120, as discussed above.

For example, the worksite controller 108 can have a work tool locator 138 that is configured with information defining the offset distance 118 associated with the vehicle 102. The work tool locator 138 can also use a history of coordinates of the location sensor 114 reported in the vehicle report 132, and previously received vehicle reports, to determine the current heading 120 of the vehicle 102, as discussed further below with respect to FIG. 2. The work tool locator 138 can accordingly determine coordinates of the work tool point 116 based on the determined heading 120, the predefined offset distance 118, and the coordinates of the location sensor 114 included in the vehicle report 132, as discussed further below with respect to FIG. 3.

In other examples, the location data 136 in the vehicle report 132 can directly indicate coordinates of the work tool point 116 determined by the vehicle 102, instead of or in addition to coordinates of the location sensor 114. For example, the vehicle 102 can have an electronic control module (ECM) or other on-board computing device that can determine the heading 120 of the vehicle 102, and can receive an indication of the coordinates of the location sensor 114 from the location sensor 114. Accordingly, the ECM, or other on-board computing device, can determine coordinates of the work tool point 116 based on the coordinates of the location sensor 114, the offset distance 118, and the heading 120. In these examples, the ECM or other on-board computing device can be configured to generate the vehicle report 132 to include location data 136 indicating the coordinates of the work tool point 116 determined on-board the vehicle 102, or to include both the coordinates of the work tool point 116 determined on-board the vehicle 102 and the coordinates of the location sensor 114.

The material tracker 130 of the work site controller 108 can be configured to use coordinates of the work tool point 116, determined by the work tool locator 138 or included directly in the vehicle report 132, to determine when the work tool 104 of the vehicle 102 is within boundaries of work zones defined by the zone data 124. The material tracker 130 can also use work event data 134 to determine if and/or when the vehicle 102 interacts with material 106 while the work tool point 116 is within the boundaries of a work zone. Accordingly, if the coordinates of the work tool point 116 indicate that the work tool 104 is within a particular work zone, and corresponding work event data 134 indicates that the vehicle 102 likely performed a work operation to interact with material 106 while the work tool 104 was within the particular work zone, the material tracker 130 can determine that the vehicle 102 likely interacted with material 106 in the particular work zone. The material tracker 130 can therefore automatically update zone data 124 and/or other material tracking data associated with the particular work zone based on a work operation that the coordinates of the work tool point 116 indicate was performed within the particular work zone, regardless of whether coordinates of the location sensor 114 itself were within the particular work zone when the work operation was performed.

FIG. 2 shows an example 200 of historical locations 202 of the vehicle 102, associated with travel of the vehicle 102 around the worksite 100 over time. As discussed above, the location sensor 114 can be configured to determine coordinates indicating locations of the location sensor 114 over time. Some or all of the coordinates determined by the location sensor 114 at different times can be stored by an ECM or other on-board computing device, and/or can be transmitted to the worksite controller 108 as location data 136. Accordingly, the vehicle 102 and/or the worksite controller 108 can determine a series of historical locations 202 indicated by the coordinates determined by the location sensor 114 over time.

The series of historical locations 202 can include coordinates of the most recent location determined by the location sensor 114 or reported to the worksite controller 108, which can reflect the current location of the cab 110 or other point on the vehicle 102 where the location sensor 114 is mounted. The series of historical locations 202 can also include coordinates of one or more previous locations determined by the location sensor 114, which can indicate previous locations of the cab 110 or other point on the vehicle 102 where the location sensor 114 is mounted.

The series of historical locations 202, corresponding to coordinates determined by the location sensor 114, can thus indicate a path traveled by the vehicle 102 through the worksite 100 over a period of time. For example, as shown in FIG. 2, the series of historical locations 202 can form a breadcrumb trail that follows the path traveled by the vehicle 102 through the worksite 100.

The vehicle 102 and/or the worksite controller 108 can use the series of historical locations 202 to determine the heading 120 of the vehicle with respect to individual historical locations 202 and/or the most recent location determined by the location sensor 114. For instance, the heading 120 of the vehicle 102 associated with the most recent location determined by the location sensor 114 can be determined based on an angle or direction between coordinates of the most recent location determined by the location sensor 114 and coordinates of the preceding location determined by the location sensor 114.

In some examples, the vehicle 102 and/or the worksite controller 108 can determine an initial value of the heading 120 based on a comparison of at least two locations determined by the location sensor 114, such as the most recent location determined by the location sensor 114 and the preceding location determined by the location sensor 114. Thereafter, the vehicle 102 and/or the worksite controller 108 can update the value of the heading 120 in association with a subsequent location determined by the location sensor 114, for instance based on an average heading, a weighted combination of headings, and/or other adjustments to the previous value of the heading 120.

As a non-limiting example, the vehicle 102 or the worksite controller 108 can determine a first value of the heading 120 in association with a first location determined by the location sensor 114, for instance based on a first directional angle between the first location and a preceding location determined by the location sensor 114. When the location sensor 114 determines a second location, the vehicle 102 or the worksite controller 108 can determine a second directional angle between the second location and the first location. The vehicle 102 or the worksite controller 108 can determine a second value for the heading 120 based on an average or weighted combination of the first value of the heading 120 and the second directional angle. In some situations, using an average or weighted combination to determine the heading 120 can smooth out noise in values of the heading 120 over time.

Accordingly, in some examples, the vehicle 102 and/or the worksite controller 108 can use a comparison of two or more historical locations 202 determined by the location sensor 114 over time to determine the heading 120 of the vehicle 102 at individual historical locations 202, including at the most recent location determined by the location sensor 114. In other examples, the vehicle 102 can directly determine the heading 120 associated with individual historical locations 202. For instance, the ECM of the vehicle 102 may have access to data provided by a compass of the vehicle 102, more granular location data that is measured or generated by the location sensor 114 that is not otherwise transmitted to the worksite controller 108, data from rotational sensors, inertial sensors, and/or other sensors of the vehicle 102, and/or other data that may indicate the heading 120 of the vehicle 102 at individual historical locations 202.

When the vehicle 102 and/or the worksite controller 108 determines the heading 120 of the vehicle 102, for instance in association with the last location determined by the location sensor 114, the vehicle 102 and/or the worksite controller 108 can use the heading 120 to determine the location of the work tool point 116. As discussed above, the work tool 104 may be located away from the coordinates determined by the location sensor 114. However, the location of the work tool point 116 on, or associated with, the work tool 104 can be determined based on the coordinates determined by the location sensor 114, the heading 120, and the offset distance, as discussed further below with respect to FIG. 3.

FIG. 3 shows an example 300 of determining a location of the work tool point 116. As discussed above, the location of the work tool point 116 can be at coordinates that are the offset distance 118 away from the coordinates of the location sensor 114, along a line oriented according to the heading 120.

Accordingly, the coordinates of the work tool point 116 can be at a point around the circumference of a circle 302 that is centered at the coordinates of the location sensor 114. The circle 302 can have a radius equal to the offset distance 118. The work tool point 116 can be a point on the circumference of the circle 302 that intersects a line extending from the center of the circle based on the heading 120 of the vehicle 102.

As shown in FIG. 3, the coordinates of the location sensor 114 alone may not directly indicate the coordinates of the work tool point 116. For instance, the work tool point 116 could be at any point on the circumference of the circle 302 that is the offset distance 118 away from the coordinates of the location sensor 114. However, the coordinates of the work tool point 116 can be determined based on an intersection of the circumference of the circle 302 and a line that extends from the coordinates of the location sensor 114 at an angle corresponding to the heading 120.

As such, if the location data 136 in the vehicle report 132 only indicates the coordinates of the location sensor 114 itself, the worksite controller 108 can determine the coordinates of the work tool point 116 based on the reported coordinates of the location sensor 114, the offset distance 118, and the heading 120. The worksite controller 108 can accordingly use the determined coordinates of the work tool point 116 to determine whether the vehicle 102 interacted with material 106 within a defined work zone, even if the reported coordinates of the location sensor 114 were not within that work zone or were within a different work zone, as discussed below with respect to FIG. 4.

FIG. 4 shows an example 400 of a situation in which determining a location of a work tool point, associated with a work tool of a vehicle, can be used to track material 106 on the worksite 100. As discussed above with respect to FIG. 1, the worksite controller 108 can maintain zone data 124 that indicates information associated with defined work zones on the worksite 100. For example, the zone data 124 can indicate locations and boundaries of one or more work zones on the worksite 100, such as a first work zone 402 and a second work zone 404 as shown in FIG. 4. The zone data 124 can also indicate types and/or amounts of material 106 associated with corresponding work zones. For example, the first work zone 402 can be associated with a first material 406, and the second work zone 404 can be associated with a second material 408.

In some examples, the defined boundaries of one work zone may be relatively close to the defined boundaries of another work zone on the worksite 100. Additionally, in some examples, some of the material 106 associated with a particular work zone may be located relatively close to the defined boundaries of the particular work zone. However, although the work zones may be located relatively close together on the worksite 100, and/or material 106 may be relatively close to the edges of one or more work zones, the worksite controller 108 can use locations of work tool points associated with work tools of vehicles to automatically determine when vehicles are likely interacting with material 106 at defined work zones.

As a non-limiting example, a first vehicle 410 can be associated with a first location sensor 412 and a first work tool point 414. The first location sensor 412 can be the same or similar to the location sensor 114, and can be at a fixed position on a cab of the first vehicle 410 or at another fixed position on the first vehicle 410. The first work tool point 414 can be at a first offset distance away from the position of the first location sensor 412 on the first vehicle 410, for instance at a front edge of a bucket or other work tool of the first vehicle 410.

In this example, the location of the first location sensor 412 of the first vehicle 410, and thus coordinates determined by the first location sensor 412, can be between the first work zone 402 and the second work zone 404. Accordingly, the coordinates determined by the first location sensor 412, alone, may be insufficient to determine whether the first vehicle 410 is interacting with material 106 in either the first work zone 402 or the second work zone 404. However, coordinates of the first work tool point 414 can be determined based on the coordinates determined by the first location sensor 412, a heading of the first vehicle 410, and the first offset distance that separates the first location sensor 412 and the first work tool point 414, for instance as discussed above with respect to FIG. 3. In this example, the heading of the first vehicle 410 is directed from first location sensor 412 toward the first work zone 402. The worksite controller 108 can accordingly determine that, although the location of the first location sensor 412 is not within the first work zone 402, the location of the first work tool point 414 is within the first work zone 402.

Work event data 134 shared by the first vehicle 410 may indicate that the first vehicle 410 performed a work operation while the first work tool point 414 was within the first work zone 402. For instance, the work event data 134 may indicate that the first vehicle 410 likely performed an operation to pick up material 106 or drop off material 106. The material tracker 130 can accordingly associate the work operation of the first vehicle 410 with the first work zone 402 and/or the first material 406 associated with the first work zone 402. For example, the material tracker 130 of the worksite controller 108 can edit zone data 124 to adjust an amount of the first material 406 associated with the first work zone 402. In this example, the worksite controller 108 can determine that the first vehicle 410 interacted with the first material 406 in the first work zone 402 based on the determined location of the first work tool point 414, even though the location of the first location sensor 412 was not within the first work zone 402.

As another non-limiting example, a second vehicle 416 can be associated with a second location sensor 418 and a second work tool point 420. The second location sensor 418 can be the same or similar to the location sensor 114, and can be at a fixed position on a cab of the second vehicle 416 or at another fixed position on the second vehicle 416. The second work tool point 420 can be at a second offset distance away from the position of the second location sensor 418 on the second vehicle 416, for instance at a front edge of a bucket or other work tool of the second vehicle 416.

The second offset distance associated with the second vehicle 416 can be the same as the first offset distance associated with the first vehicle 410, for instance if the first vehicle 410 and the second vehicle 416 are the same model or type of vehicle. However, in other examples, the second offset distance associated with the second vehicle 416 can be different than the first offset distance associated with the first vehicle 410, for instance if the first vehicle 410 and the second vehicle 416 are different models, different types of vehicles, have different types of work tools, have locations sensors at different fixed positions, and/or otherwise have different distances between location sensors and work tool points.

In this example, the location of the second location sensor 418 of the second vehicle 416, and thus coordinates determined by the second location sensor 418, can be within the boundaries of the first work zone 402. However, the coordinates determined by the second location sensor 418, alone, may be insufficient to determine whether the second vehicle 416 is interacting with material 106 in either the first work zone 402 or the second work zone 404. For example, because the boundaries of the first work zone 402 and the second work zone 404 can be relatively close together on the worksite 100, the work tool of the second vehicle 416 can be interacting with the second material 408 in the second work zone 404 even though the second location sensor 418 is within the first work zone 402.

However, coordinates of the second work tool point 420 can be determined based on the coordinates determined by the second location sensor 418, a heading of the second vehicle 416, and the second offset distance that separates the second location sensor 418 and the second work tool point 420, for instance as discussed above with respect to FIG. 3. In this example, the heading of the second vehicle 416 is directed from second location sensor 418 toward the second work zone 404. The worksite controller 108 can accordingly determine that, although the location of the second location sensor 418 is within the first work zone 402, the location of the second work tool point 420 is within the second work zone 404.

Work event data 134 shared by the second vehicle 416 may indicate that the second vehicle 416 performed a work operation while the second work tool point 420 was within the second work zone 404. For instance, the work event data 134 may indicate that the second vehicle 416 performed an operation to pick up material 106 or drop off material 106. The material tracker 130 can accordingly associate the work operation of the second vehicle 416 with the second work zone 404 and/or the second material 408 associated with the second work zone 404. For example, the material tracker 130 of the worksite controller 108 can edit zone data 124 to adjust an amount of the second material 408 associated with the second work zone 404. In this example, the work site controller 108 can determine that the second vehicle 416 interacted with the second material 408 in the second work zone 404 based on the determined location of the second work tool point 420, even though the location of the second location sensor 418 was within the first work zone 402 and was not within the second work zone 404.

Overall, the worksite controller 108 can use coordinates of work tool points on work tools of vehicles, instead of coordinates of location sensors positioned elsewhere on vehicles, to automatically track material 106 around the worksite 100. For example, if coordinates of work tool points and corresponding work event data indicates that work tools of vehicles likely moved material 106 from the first work zone 402 to the second work zone 404, the worksite controller 108 can automatically adjust zone data 124 to decrement a first material amount value indicating an amount of the material 106 stored at the first work zone 402 and to correspondingly increment a second material amount value indicating an amount of the material 106 stored at the second work zone 404,

In some examples, the work site controller 108 can also automatically adjust the zone data 124 to change locations and/or boundaries of work zones, or use the user interface 128 to suggest that users change locations and/or boundaries of work zones. As a non-limiting example, the worksite controller 108 can determine that, over a period of time, an average location of work tool points within the first work zone when likely work events are detected has shifted north by ten meters. This analysis may indicate that work events over the period of time have likely moved a southern edge of the pile of the first material 406 approximately ten meters north. The worksite controller 108 can accordingly automatically adjust zone data 124 to shift a southern boundary of the first work zone 402 north by a corresponding distance, or present a notification to a user via the user interface 128 that recommends that the user revise the boundaries of the first work zone 402.

As another non-limiting example, the worksite controller 108 can use a clustering analysis to determine that a cluster of locations of work tool points associated with likely work events are outside the boundaries of existing work zones. Accordingly, the worksite controller 108 can automatically create a new work zone around the detected cluster of work tool point locations, expand the boundaries of another work zone to encompass the detected cluster of work tool point locations, or provide a suggestion to a user via the user interface 128 that the user create a new work zone surrounding the detected cluster of work tool point locations.

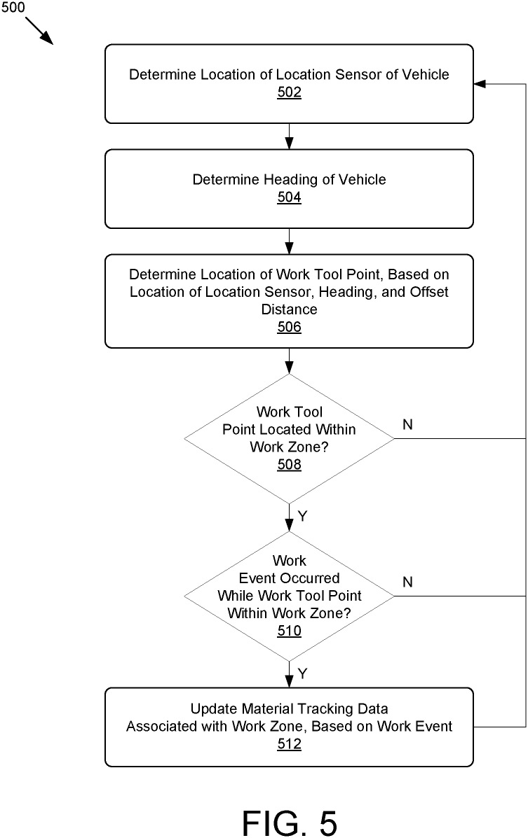

FIG. 5 shows a flowchart 500 illustrating an example process for tracking material 106 on the work site 100, based at least in part on determining whether work events associated with the vehicle 102 occur while the work tool point 116 is within a defined work zone. The operations shown in FIG. 5 can be performed by a system that includes the worksite controller 108 and/or one or more on-board computing devices of the vehicle 102, such as an ECM,

At block 502, the system can determine a location of the location sensor 114 of the vehicle 102. For example, the system can use coordinates determined by the location sensor 114 of the vehicle 102 to determine the location of the location sensor 114. In some examples in which the system is the worksite controller 108, the worksite controller 108 can determine the coordinates of the location of the location sensor 114 based on the location data 136 in the vehicle report 132.

At block 504, the system can determine the heading 120 of the vehicle 102. In some examples, the system can use the location of the location sensor 114 determined at block 502, and one or more previously determined locations of the location sensor 114, to determine the heading 120 of the vehicle 102. For instance, in examples in which the system is the worksite controller 108, the worksite controller 108 can use location data 136 included in the vehicle report 132, and one or more previous vehicle reports, to determine a series of historical locations 202 indicated by the coordinates determined by the location sensor 114 over time. The worksite controller 108 can determine the current heading 120 of the vehicle 102 based on the most recent coordinates determined by the location sensor 114 and at least one set of preceding coordinates determined by the location sensor 114, as described above with respect to FIG. 2.

In other examples, the system can determine the heading 120 of the vehicle 102 at block 504 based on compass data, granular location data provided by the location sensor 114, data from rotational sensors, inertial sensors, and/or other sensors of the vehicle 102, and/or other types of data. For example, the ECM of the vehicle may have access to such data, in addition to the location data 136 provided to the worksite controller in the vehicle report 132, such that the ECM can determine the heading 120 at block 504.

At block 506, the system can determine the location of the work tool point 116. The system can determine location of the work tool point 116 based on the location of the location sensor 114 determined at block 502, the heading 120 of the vehicle 102 determined at block 504, and the offset distance 118 that separates the work tool point 116 from the position of the location sensor 114 on the vehicle 102. The system can be pre-configured with data that indicates the offset distance 118 associated with the vehicle 102. The system can determine the location of the work tool point 116 by determining coordinates that are the offset distance 118 away from the coordinates of the location of the location sensor 114, along a line oriented based on the direction of the heading 120, for example as discussed above with respect to FIG. 3. For instance, at block 506, the system can determine the coordinates of the work tool point 116 by adjusting the coordinates of the location sensor 114 determined at block 502, by the offset distance 118, in a direction indicated by the heading 120 determined at block 504.

In some examples, the worksite controller 108 can perform the operations of block 502, block 504, and block 506. For instance, at block 502, the worksite controller 108 can determine the location of the location sensor 114 based on location data 136 received in the vehicle report 132 from the vehicle 102. At block 504, the worksite controller 108 can determine the heading 120 of the vehicle 102 based on the location data 136 in the most recently received vehicle report 132 and one or more previous vehicle reports received by the worksite controller 108 from the vehicle 102. At block 506, the worksite controller 108 can determine the location of the work tool point 116 based on the location data 136 received in the most recent vehicle report 132, the heading 120 determined by the worksite controller 108, and the offset di stance 118 associated with the vehicle 102. The worksite controller 108 can accordingly perform further operations described below with respect to block 508, block 510, and block 512 based on the location of the work tool point 116 determined by the worksite controller 108 at block 506.

In other examples, the ECM of the vehicle 102 can perform the operations of block 502, block 504, and block 506. For instance, at block 502, the ECM can determine the location of the location sensor 114 based on coordinates provided directly to the ECM by the location sensor 114. At block 504, the ECM can determine the heading 120 of the vehicle 102 based on coordinates of a series of historical locations 202 provided by the location sensor 114 to the ECM, compass data, data from rotational sensors, inertial sensors, and/or other sensors of the vehicle 102, and/or other types of data. In some examples, the ECM can have access to more granular location data from the location sensor 114 than is included in vehicle reports sent to the worksite controller 108. For example, if the vehicle 102 transmits vehicle reports with new location data 136 to the worksite controller 108 every five seconds, the ECM may have access to coordinates determined by the location sensor 114 on a more frequent basis, such as every second. Accordingly, the ECM can use the more frequent location data to determine the heading 120 of the vehicle 102 at block 504, instead of or in addition to the less frequent location data 136 transmitted to the worksite controller 108. At block 506, the ECM can determine the location of the work tool point 116 based on the coordinates provided directly to the ECM by the location sensor 114, the heading 120 determined by the ECM, and the offset distance 118 associated with the vehicle 102.

In examples in which the ECM of the vehicle 102 performs the operations of block 502, block 504, and block 506, the location data 136 provided in the vehicle report 132 can indicate coordinates of the location of the work tool point 116 determined by the ECM of the vehicle 102. Accordingly, the worksite controller 108 can perform further operations described below with respect to block 508, block 510, and block 512 based on the location of the work tool point 116 that is determined by the ECM on-board the vehicle 102 and that is indicated by the location data 136 in the vehicle report 132 received by the worksite controller 108.

At block 508, the system can determine whether the work tool point 116 is within a work zone, based on zone data 124 associated with the worksite 100 and the location of the work tool point 116 determined at block 506. For example, the worksite controller 108 can compare the location of the work tool point 116 determined at block 506 against locations and boundaries of one or more work zones defined by zone data 124, and determine whether the location of the work tool point 116 is within defined boundaries of any of the work zones. If the system determines at block 508 that the work tool point 116 is not within a work zone (Block 508-No), the system can return to blocks 502-506 to determine a next location of the work tool point 116, and then determine at block 508 whether the next location of the work tool point 116 is within a work zone.

However, if the system determines that the work tool point 116 is within a work zone (Block 508 - Yes), the system can determine at block 510 whether the vehicle 102 engaged in a work event associated with material 106 while the work tool point 116 was within that work zone. The system can determine at block 510 whether the vehicle 102 engaged in a work event, while the work tool point 116 was within a work zone, based on work event data 134 included in the vehicle report 132.

For example, work event data 134 included in the vehicle report 132 can be associated with a timestamp that corresponds with a time that the work tool point 116 is determined to have been within the work zone. As discussed above, the work event data 134 can indicate information determined by sensors and/or other components of the vehicle 102, such as payload amounts, movements of the work tool 104, hydraulic pressures, and/or other types of data that can be indicative of work events. For example, is the work event data 134 indicates that a payload and/or hydraulic pressures associated with the work tool 104 increased at a time at which the work tool point 116 is determined to have been within a particular work zone, the system can determine that the work tool 104 performed an operation within the particular work zone to pick up material 106 associated with the particular work zone. Similarly, if the work event data 134 indicates that a payload and/or hydraulic pressures associated with the work tool 104 decreased at the time at which the work tool point 116 is determined to have been within a particular work zone, the system can determine that the work tool 104 performed an operation within the particular work zone to drop off material 106 associated with the particular work zone.

Payload amounts, hydraulic pressures, and/or other information in the work event data 134 can also indicate how much material 106 was picked up or dropped off by the vehicle 102 at a work zone. For example, information in the work event data 134 can indicate a force applied by the work tool 104 during a work operation, which the worksite controller 108 can use to determine an amount of the material 106 that was moved by the work tool 104 based on a weight or mass of the material 106. Zone data 124 associated with the work zone can indicate a type of the material 106 stored in the work zone, and/or attributes of the material 106 such as a weight or mass of a unit of the material 106.

If the system determines that the work tool point 116 was within a work zone, but that a work event did not occur while the work tool point 116 was within the work zone (Block 510 - No), the system can return to blocks 502-508 to determine whether a next location of the work tool point 116 is within a work zone. The system can also determine at block 510 whether corresponding work event data 134 indicates that a work event occurred while the work tool point 116 was within a work zone.

However, if the system determines that the work tool point 116 was within a work zone, and that a work event did occur while the work tool point 116 was within the work zone (Block 510 - Yes), at block 512 the system can update material tracking data associated with the work zone based on the work event. For example, the material tracker 130 of the worksite controller 108 can determine, based on the work event data 134, an estimate of how much material 106 was added to the work zone or removed from the work zone during the work event. If the material tracker 130 determines that an amount of material 106 was likely added, by the work tool 104 of the vehicle 102, to the work zone during the work event, the material tracker 130 can adjust zone data 124 associated with the work zone to increment data indicating an overall amount of the material 106 stored at the work zone. Similarly, if the material tracker 130 determines that an amount of material 106 was likely removed, by the work tool 104 of the vehicle 102, from the work zone during the work event, the material tracker 130 can adjust zone data 124 associated with the work zone to decrement data indicating an overall amount of the material 106 stored at the work zone.

After updating the material tracking data associated with the work zone at block 512, the system can return to blocks 502-510 to determine whether a next location of the work tool point 116 is within the same or a different work zone, and whether corresponding work event data 134 indicates that a new work event occurred while the work tool point 116 was within the same or a different work zone. The system can also further update material tracking data associated with the same or a different work zone based on the new work event.

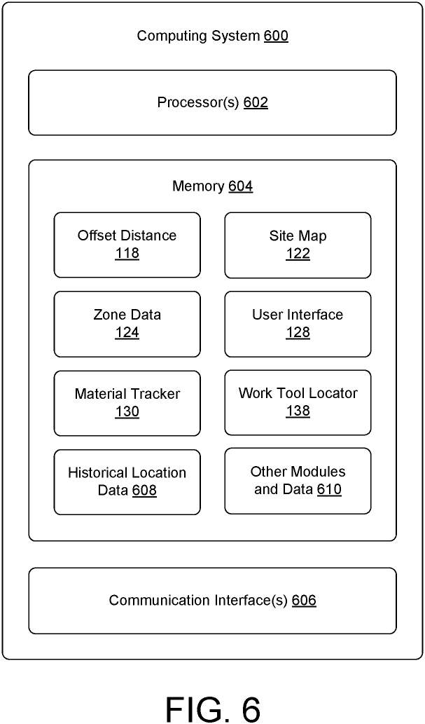

As discussed above, in some examples, the operations shown in FIG. 5 can be performed by the worksite controller 108. In other examples, one or more of the operations shown in FIG. 5, or related operations, can also or alternately be performed by an ECM or other on-board computing system of the vehicle 102. FIG. 6, discussed further below, describes an example system architecture for a computing system, such as the worksite controller 108 or an ECM or other computing system on-board the vehicle 102, that can perform some or all of the operations of FIG. 5.

FIG. 6 shows an example system architecture for a computing system 600. In some examples, the computing system 600 can be the worksite controller 108 described above, or another server or computer that is remote from the vehicle 102. In other examples, the computing system 600 can be an ECM or other on-board computing system of the vehicle 102. In some examples, elements of the computing system 600 can be distributed between the worksite controller 108 and the vehicle 102. The computing system 600 can include one or more computing devices or other controllers that include one or more processors 602, memory 604, and communication interfaces 606.

The processor(s) 602 can operate to perform a variety of functions as set forth herein. The processor(s) 602 can include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 602 can have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 602 can also access content and computer-executable instructions stored in the memory 604, and execute such computer-executable instructions.

The memory 604 can be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media can be non-transitory computer-readable media. The computer-readable media can be configured to store computer-executable instructions that can be executed by the processor(s) 602 to perform the operations described herein.

For example, the memory 604 can include a drive unit and/or other elements that include machine-readable media. A machine-readable medium can store one or more sets of instructions, such as software or firmware, that embodies any one or more of the methodologies or functions described herein. The instructions can also reside, completely or at least partially, within the processor(s) 602 and/or communication interface(s) 606 during execution thereof by the computing system 600. For example, the processor(s) 602 can possess local memory, which also can store program modules, program data, and/or one or more operating systems.

The memory 604 can store an indication of the offset distance 118 associated with the vehicle 102, the site map 122, the zone data 124, elements associated with the user interface 128, the material tracker 130, the work tool locator 138, historical location data 608, and/or other modules and data 610. In some examples, the memory 604 can store a set of offset distances associated with different vehicles and/or vehicle types, such that the work tool locator 138 and/or other elements of the computing system 600 can access and use the specific offset distance 118 associated with the vehicle 102. The historical location data 608 can be a database, table, or other record of historical locations 202 associated with the vehicle 102. The other modules and data 610 can be utilized by the computing system 600 to perform or enable performing any action taken by the computing system 600. For example, the other modules and data 610 can include a platform, operating system, and/or applications, as well as data utilized by the platform, operating system, and/or applications.

The communication interfaces 606 can include transceivers, modems, interfaces, antennas, and/or other components that can transmit and/or receive data over networks or other data connections. In some examples, the communication interfaces 606 can be the wireless communication interfaces of the vehicle 102 or the worksite controller 108 discussed above. For example, the communication interfaces 606 can be configured to send the vehicle report 132 to the worksite controller 108, or to receive the vehicle report 132 from the vehicle 102.

### Industrial Applicability

As described above, the worksite controller 108 can use a location of the work tool point 116 associated with the work tool 104 of the vehicle 102, rather than a location of the location sensor 114 positioned elsewhere on the vehicle 102, to automatically determine when the vehicle 102 is interacting with material 106 in work zones on the worksite 100. The location of the work tool point 116 can indicate when the work tool 104 is within a defined work zone, even if a corresponding location of the location sensor 114 is outside the work zone or is in a different work zone. Accordingly, the worksite controller 108 can use the location of the work tool point 116 to better track movement of material 106 on the worksite 100, better determine when the vehicle 102 is engaged in a work cycle associated with movement of material, and/or otherwise use the location of the work tool point 116 to improve the accuracy of data associated with the worksite 100.

As a non-limiting example, location data 136 that indicates coordinates of the location sensor 114 itself may allow the worksite controller 108 to track material 106 around the worksite 100 with approximately 90% accuracy in some cases. For instance, during many work cycles, the vehicle 102 may drive fully into a defined work zone before interacting with material 106 in the work zone. Accordingly, the location of the cab 110 of the vehicle 102, indicated by the coordinates of the location sensor 114, may be inside the boundaries of the work zone and allow the worksite controller 108 to determine that the vehicle 102 interacted with material 106 in that work zone during a work event. However, as discussed above with respect to FIG. 4, there can be edge cases in which the cab 110 of the vehicle 102 is outside a work zone while the work tool 104 of the vehicle 102 is interacting with material 106 in that work zone, or in which the cab 110 of the vehicle 102 is inside a different work zone than the work tool 104 of the vehicle 102. In such edge cases, using the coordinates provided by the location sensor 114 at the cab 110 alone can cause the worksite controller 108 to miss work events associated with work zones, or associated work events with the wrong work zones.

However, by instead using the location of the work tool point 116 to determine which work zone the work tool 104 of the vehicle 102 is within when the vehicle 102 performs a work event, the worksite controller 108 can better account for such edge cases. For example, the worksite controller 108 can use the location of the work tool point 116 to better determine that a work event associated with material 106 is associated with a particular work zone, even if the coordinates provided by the location sensor 114 are outside that particular work zone. In some cases, using the location of the work tool point 116, instead of using the location of the location sensor 114, can allow the worksite controller 108 to improve an accuracy of tracking material 106 around the worksite 100 from approximately 90% to 95% or above.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A computer-implemented method, comprising:
receiving, by one or more processors, location data indicating first coordinates determined by a location sensor of a vehicle, wherein the location sensor is positioned on the vehicle an offset distance away from a work tool point associated with a work tool of the vehicle;
determining, by the one or more processors, a heading of the vehicle, based on the first coordinates and at least one preceding set of coordinates determined by the location sensor of the vehicle;
determining, by the one or more processors, second coordinates of the work tool point, by adjusting the first coordinates by the offset distance along a direction indicated by the heading,
determining, by the one or more processors, that the second coordinates of the work tool point are within boundaries of a work zone;
determining, by the one or more processors, that the vehicle engaged in a work event associated with a material, at a time at which the second coordinates of the work tool point are within the boundaries of the work zone; and
adjusting, by the one or more processors, zone data associated with the work zone, by changing a material amount value indicating an amount of the material stored in the work zone based on the work event.

2. The computer-implemented method of claim 1, wherein the location sensor is positioned at a cab of the vehicle proximate to a midpoint of the vehicle, and the work tool is positioned proximate to a front end of the vehicle.

3. The computer-implemented method of claim 1, wherein determining that the vehicle engaged in the work event comprises:
receiving work event data from the vehicle that is indicative of an occurrence of the work event; and
determining that the vehicle engaged in the work event based on the work event data.

4. The computer-implemented method of claim 3, wherein the work event data indicates one or more of:
payload data associated with the work tool,
movement data associated with movements of the work tool, or
hydraulic pressures associated with the work tool.

5. The computer-implemented method of claim 1, wherein the first coordinates determined by the location sensor are outside the boundaries of the work zone.

6. The computer-implemented method of claim 5, wherein the first coordinates determined by the location sensor are within second boundaries of a second work zone.

7. The computer-implemented method of claim 1, wherein determining the heading of the vehicle comprises adjusting an existing value of the heading, previously determined based on the at least one preceding set of coordinates, based on an angle between the first coordinates and a most recent set of coordinates indicated by the at least one preceding set of coordinates.

8. A computing system, comprising:
one or more processors; and
memory storing computer-executable instructions that, when executed by the one or more processors, cause the one or more processors to perform operations comprising:
receiving location data indicating first coordinates of a location sensor of a vehicle, wherein the location sensor is positioned on the vehicle an offset distance away from a work tool point associated with a work tool of the vehicle;
determining a heading of the vehicle, based on the first coordinates and at least one preceding set of coordinates determined by the location sensor of the vehicle,
determining second coordinates of the work tool point, by adjusting the first coordinates by the offset distance along a direction indicated by the heading;
determining that the second coordinates of the work tool point are within boundaries of a work zone;
determining that the vehicle engaged in a work event associated with a material, at a time at which the second coordinates of the work tool point are within the boundaries of the work zone; and
adjusting zone data associated with the work zone, by changing a material amount value indicating an amount of the material stored in the work zone based on the work event.

9. The computing system of claim 8, wherein the location sensor is positioned at a cab of the vehicle proximate to a midpoint of the vehicle, and the work tool is positioned proximate to a front end of the vehicle.

10. The computing system of claim 8, wherein determining that the vehicle engaged in the work event comprises:
receiving work event data from the vehicle that is indicative of an occurrence of the work event; and
determining that the vehicle engaged in the work event based on the work event data.

11. The computing system of claim 8, wherein the first coordinates determined by the location sensor are outside the boundaries of the work zone.

12. The computing system of claim 8, wherein determining the heading of the vehicle comprises adjusting an existing value of the heading, previously determined based on the at least one preceding set of coordinates, based on an angle between the first coordinates and a most recent set of coordinates indicated by the at least one preceding set of coordinates.

13. A worksite controller, comprising:
one or more processors; and
memory storing:
zone data associated with a work zone on a worksite, the zone data indicating:
boundaries of the work zone; and
an amount of a material stored at the work zone;
computer-executable instructions that, when executed by the one or more processors, cause the one or more processors to perform operations comprising:
receiving, from a vehicle, a vehicle report indicating work event data and location data;
determining, based on the location data, a geographical location of a work tool point on a work tool of the vehicle,
determining that the geographical location of the work tool point is within the boundaries of the work zone;
determining, based on the work event data, that the vehicle engaged in a work event associated with the material, at a time at which the geographical location of the work tool point is within the boundaries of the work zone; and
adjusting, in the zone data, the amount of the material stored at the work zone based on the work event data.

14. The worksite controller of claim 13, wherein the location data in the vehicle report directly indicates the geographical location of the work tool point.

15. The worksite controller of claim 13, wherein:
the location data in the vehicle report indicates coordinates of a location sensor that is positioned on the vehicle an offset distance away from the work tool point, and
the operations further comprise:
determining a heading of the vehicle, based on the coordinates of the location sensor indicated in the vehicle report and at least one preceding set of coordinates of the location sensor indicated by one or more previously-received vehicle reports; and
determining the geographical location of the work tool point by adjusting the coordinates by the offset distance along a direction indicated by the heading.

16. The worksite controller of claim 13, wherein the operations further comprise determining, based on determining one or more additional geographical locations of the work tool point over a period of time, that at least one additional work event associated with the material occurred at a location outside the boundaries of the work zone.

17. The worksite controller of claim 16, wherein the operations further comprise at least one of automatically adjusting the boundaries of the work zone to encompass the location, or creating a new work zone that encompasses the location.

18. The worksite controller of claim 16, wherein the operations further comprise at least one of presenting a suggestion, via a user interface of the worksite controller, to adjust the boundaries of the work zone to encompass the location, or to create a new work zone that encompasses the location.

19. The worksite controller of claim 13, wherein:
the work zone is a first work zone,
the amount of the material is a first amount of the material stored at the first work zone,
the zone data further indicates:
second boundaries of a second work zone on the worksite; and
a second amount of the material stored at the second work zone, and
the operations further comprise:
determining, based on the geographical location and one or more additional geographical locations of the work tool point over a period of time, that the vehicle moved a particular amount of the material from the first work zone to the second work zone;
decrementing the first amount of the material stored at the first work zone based on the particular amount of the material; and
incrementing the second amount of the material stored at the second work zone based on the particular amount of the material.

20. The worksite controller of claim 19, wherein the operations further comprise determining an average work cycle time associated with transport of the material from the first work zone to the second work zone by the vehicle, based on the geographical location and the one or more additional geographical locations of the work tool point over a second period of time.
